(19) United States
(12) Patent Application Publication
(10) Pub. No.: US 2012/0233325 A1
(43) Pub. Date: Sep. 13, 2012

(54) Method and system for implementing usage monitoring control

(75) Inventors: Xiaoyun Zhou, Shenzhen (CN); Zaifeng Zong, Shenzhen (CN); Jinhua Wu, Shenzhen (CN)

(73) Assignee: ZTE CORPORATION, Shenzhen, Guangdong (CN)

(21) Appl. No.: 13/510,653

(22) PCT Filed: Nov. 15, 2010
(86) PCT No.: PCT/CN2010/078718

§ 371 Date: May 18, 2012

(30) Foreign Application Priority Data
Nov. 30, 2009 (CN) 200910205979.5

(51) Int. Cl. G06F 15/173

(52) U.S. Cl. 709/224

(57) ABSTRACT

The present disclosure discloses a method for implementing usage monitoring control, a total allowanced usage is prestored in a Subscription Profile Repository (SPR), the SPR sets an allowanced usage threshold according to a request from a Policy and Charging Rules Function (PCRF) and distributes the set allowanced usage threshold to the PCRF; the PCRF makes a usage monitoring policy according to the obtained allowanced usage threshold; after receiving a usage report of the PCRF, the SPR deducts a consumed usage from the total allowanced usage shared by multiple users. The present disclosure also provides a system for implementing usage monitoring control. Through the solution of the present disclosure, when multiple users share a total allowanced usage, PCRF simultaneously monitors the usage on the multiple users according to the total allowanced usage, thereby avoiding conflicts in policy and charging controls.

### TECHNICAL FIELD

The present disclosure relates to policy and charging technology, and more particularly to a method and system for implementing usage monitoring control.

### BACKGROUND

Since the release of the 3rd Generation Partnership Project Release 7 (3GPP Release 7), policy and charging function is achieved by Policy and Charging Control (PCC) frame. PCC architecture is a functional frame that can be applied to multiple access technologies, for example, PCC architecture can be applied to Terrestrial Radio Access Network (UTRAN) of Universal Mobile Telecommunications System (UMTS), Global system for Mobile Communication (GSM)/Enhanced Data Rate for GSM Evolution (EDGE) radio access network, Interworking-Wireless Local Area Network (I-WLAN) and Evolved Packet System (EPS).

PCC mainly achieves two functions of policy control and charging. FIG. 1 is a schematic diagram of the architecture of existing PCC, and each logic functional entity in the PCC architecture as shown in FIG. 1 and the interface functions thereof are described below. As shown in FIG. 1,

Application Function (AF) is used to provide an access point for the service applications, and the network resources used by these service applications require a dynamic policy control. When performing a parameter negotiation on a service panel, AF transmits related service information to a Policy and Charging Rules Function (PCRF). If the service information accords with the policy of the PCRF, the PCRF accepts the negotiation; otherwise, the PCRF refuses the negotiation and gives service parameters that are acceptable by the PCRF in the feedback. Then, the AF may return these parameters to a User Equipment (UE). Wherein the interface between the AF and the PCRF is a Rx interface.

PCRF, which is the core of PCC, is responsible for making policy and charging rule. The PCRF provides network control rules based on service data flows, these network controls include: the detection of the service data flow, Gating Control, Quality of Service (QoS) control and charging rules based on data flows. The PCRF transmits the made policy and charging rules to a Policy and Control Enforcement Function (PCEF) to be implemented; meanwhile, the PCRF is also required to guarantee that theses rules are in accordance with the subscription information of the user. Wherein the policy and charging rules made by the PCRF include: service-related information obtained from the AF; user policy and charging control subscription information related to the policy control and charging obtained from a Subscription Profile Repository (SPR); information related to a bearer network obtained from the PCEF via a Gx interface.

The PCEF generally locates within a Gateway (GW), and implements the policy and charging rules made by the PCRF on a bearing panel. The PCEF detects service data flows according to a service data flow filter contained in the rule transmitted from the PCRF, so as to perform the policy and charging rules made by the RCRF on the service data flows; when establishing a bearer, the PCEF performs QoS authorization according to the rules transmitted by the PCRF, and performs gating control according to execution of the AF; meanwhile, the PCEF triggers reporting of an event occurred on the bearer network according to the events subscribed by the PCRF; according to the charging rules transmitted from the PCRF, PCEF performs charging operation for corresponding service data flows, wherein the charging may be online or offline. In the case of an online charging, it is necessary that the PCEF performs a credit management together with an Online Charging System (OCS); and in the case of an offline charging, the PCEF exchanges related charging information with an Offline Charging System (OFCS). Wherein the interface between the PCEF and the PCRF is a Gx interface, and the interface between the PCEF and the OCS is a Gy interface, and the interface between the PCEF and the OFCS is a Gz interface. The PCEF generally locates on the gateway of a network, for example, Packet Data Network-Gate Way (PDN-GW) of EPS, Gateway GPRS Support Node (GGSN) of General Packet Radio Service (GPRS) and Packet Data Gateway (PDG) of Interworking WLAN (I-WLAN).

Bearer Binding and Event Reporting Function (BBERF) generally locates within an access network gateway. For instance, if a user equipment accesses an EPS via an E-UTRAN and Proxy Mobile Internet Protocol version 6 (PMIPv6) is employed between the S-GW and the P-GW, then the BBERF exists in the S-GW. If a user equipment accesses via a creditable non-3GPP access network, then the BBERF also exists in the creditable non-3GPP access gateway.

The Subscription Profile Repository (SPR) stores user policy charging control subscription information related to the policy control and charging. The interface between the SPR and the PCRF is a Sp interface.

The OCS and the PCEF jointly complete the control and management of the user credit in the case of online charging.

The OFCS and the PCEF jointly complete the charging operation in the case of offline charging.

In the prior art, PCC supports dynamic usage monitoring control for performing a dynamic policy decision based on a total amount of the network resource usage in real-time. Usage monitoring can be applied to a single service data flow, a group of service data flows or all of the service flows of an IP-Connectivity Access Network (IP-CAN) session. Presently, usage refers to the data service of user panel. In the prior art, an instance required to be usage monitored is identified by a Monitoring Key, for example: if the PCRF allocates a Monitoring Key and corresponding threshold for all of the service flows in an IP-CAN session, then the PCEF monitors the traffic of all the service flows of the IP-CAN according to the threshold and identifies a reported usage with the Monitoring Key. If the PCRF allocates a Monitoring Key and corresponding threshold for one service data flow or a group of service flows, then the PCRF carries the Monitoring Key in a PCC rule corresponding to the service data flow or the group of service data flows, and monitors the traffic of the service data flows corresponding to the PCC rules having the same Monitoring Key, and identifies a reported usage with the Monitoring Key.

Meanwhile, a total allowanced usage of a certain PDN of a user may also be stored in an SPR, i.e. a total allowanced usage for all of the service flows of one IP-CAN session, which may also be referred to as a total allowanced usage per PDN per user. SPR may also stores a total allowanced usage for certain specific services of a PDN of a user, i.e. the total allowanced usage for one service data flow or a group of service data flows, which can also be identified with the Monitoring Key.

After the user establishes an IP-CAN session to a certain PDN, the SPR distributes the total allowanced usage to the PCRF. When PCRF performs a usage monitoring control, the PCRF subscribes a Usage_Report event trigger from the PCEF. After the Monitoring Key contained in the PCC rule is distributed, PCC rules having the same Monitoring Key share a threshold corresponding to the Monitoring Key. When the Monitoring Key is not contained in any PCC rule, all of the service data flows of the IP-CAN session share a threshold corresponding to the Monitoring Key. When it is monitored by PCEF that the usage reaches a threshold, an IP-CAN session terminates, all of the PCC rules containing a certain Monitoring Key are deleted or the PCRF explicitly requests a usage report, PCEF will reports the usage consumption of a related Monitoring Key since the last report to the PCRF. After the PCRF receives the usage report from the PCEF, the PCRF deducts the reported usage from the total allowanced usage. If the PCEF reports the usage of a certain Monitoring Key and a further monitoring is required, the PCRF will allocate a new threshold to the PCEF; and if no further monitoring is required, the PCRF will not allocates a new threshold to the PCEF. After the last IP-CAN session of an APN of the user terminates, the PCRF stores, in the SPR, the remaining allowanced usage comprising the total allowanced usage of the PDN or the total allowanced usage of some specific services of the PDN.

It can be seen from existing usage monitoring control scheme that existing usage monitoring control is performed for a certain PDN of a user or certain specific service flows of a certain PDN. Having some limitations, existing usage monitoring control cannot be applied in some cases, for example: for a family package, multiple users participated in this family package share a total allowanced usage of a certain PDN or a total subscription allowanced usage of certain specific service flows of a certain PDN. In this case, the PCRF should simultaneously perform a usage monitoring on multiple IP-CAN sessions to the same PDN established for multiple users participated in this family package or certain specific service flows to the same PDN.

In the prior art, when multiple users share a total allowanced usage, there is provided no solution that a PCRF simultaneously performs usage monitoring on multiple users according to a total allowanced usage. If still using existing usage monitoring control method for implementing a monitoring control on the user equipments sharing the same subscription information, then it will definitely lead to conflicts in policy and charging controls.

### SUMMARY

In view of the above, the main purpose of the present disclosure is to provide a method for implementing usage monitoring control, which is capable of implementing usage monitoring control for multiple user equipments sharing the same subscription information, and thereby avoiding conflicts in policy and charging controls.

Another purpose of the present disclosure is to provide a system for implementing a monitoring control, which is capable of implementing usage monitoring control for multiple user equipments sharing the same subscription information, and thereby avoiding conflicts in policy and charging controls.

In order to achieve the above purposes, the technical solutions of the present disclosure are implemented as follows:

a method for implementing usage monitoring control, the method includes prestoring a total allowanced usage in a SPR, the method further includes:

the SPR sets an allowanced usage threshold according to a request from a PCRF and distributes the set allowanced usage threshold to the PCRF; the PCRF makes a usage monitoring policy according to the obtained allowanced usage threshold;

the SPR deducts a consumed usage from the total allowanced usage shared by multiple users after receiving a usage report from the PCRF.

In the above solution, after the usage monitoring policy is made and before the SPR receives the usage report from the PCRF, the method may further include: the PCRF distributes the usage monitoring policy to a PCEF, and the PCEF performs a usage monitoring according to the usage monitoring policy, and reports a usage to the PCRF.

In the above solution, the usage monitoring policy may include a usage threshold, which is smaller than or equal to the allowanced usage threshold.

In the above solution, when a first user in the multiple users requests to establish an IP-CAN session, the step of obtaining, by the PCRF, the allowanced usage threshold may include:

the SPR includes the allowanced usage threshold in a subscription information of the users and returns the subscription information to the PCRF;

the allowanced usage threshold is a first allowanced usage threshold.

In the above solution, the first allowanced usage threshold may be smaller than or equal to the total allowanced usage,

the first allowanced usage threshold may be for all service data flows of a certain IP-CAN session or for one or more service data flows in a certain IP-CAN session.

In the above solution, the usage monitoring policy may include allocating, by the PCRF, a first usage threshold for a Monitoring Key, and the first usage threshold may be smaller than or equal to the first allowanced usage threshold.

In the above solution, when a second user in addition to the first user in the multiple users requests to establish an IP-CAN session,

the SPR may include a second allowanced usage threshold in the subscription information of the users and may return the subscription information to the PCRF,

wherein a sum of the first allowanced usage threshold and the second allowanced usage threshold is smaller than or equal to the total allowanced usage.

In the above solution, the usage monitoring policy may include allocating, by the PCRF, a second usage threshold for a Monitoring Key, wherein the second usage threshold is smaller than or equal to the second allowanced usage threshold.

In the above solution, a triggering condition for reporting the usage to the PCRF may be: when an event requiring a usage report is triggered; and/or when the IP-CAN session is terminated; and/or the PCRF requests the PCEF to make a report.

In the above solution, after the usage is reported to the PCRF, the method may further include: the PCRF update the allowanced usage threshold with a value of a difference between the allowanced usage threshold and a consumed usage reported by the PCEF, and when the PCRF decides to continue to perform the usage monitoring and the allowanced usage threshold at this moment is greater than 0, the PCRF reallocates a new usage threshold, wherein the new usage threshold is smaller than or equal to the updated allowanced usage threshold.

the PCEF continues the usage monitoring according to the received new usage threshold.

In the above solution, the PCRF may report the usage to the SPR when the PCRF satisfies one of or any combination of the following conditions:

the updated allowanced usage threshold is 0; when the IP-CAN session is terminated; and the SPR requests the PCRF to make a report.

In the above solution, the step that the SPR deducts the consumed usage from the total allowanced usage shared by the multiple users may include:

if the usage report received by the SPR is an allowanced usage consumption value, then the total allowanced usage is updated with a value of a difference between the total allowanced usage and the received allowanced usage consumption value; if the usage report received by the SPR is a remaining allowanced usage, then the total allowanced usage is updated with a value of a difference between the total allowanced usage and the allowanced usage threshold, plus the received remaining allowanced usage.

The present disclosure provides a system for implementing usage monitoring control, including at least a PCRF and an SPR, wherein

the SPR is configured to store a total allowanced usage, set an allowanced usage threshold, and distribute the allowanced usage threshold according to a request of the PCRF; receive a usage report from the PCRF, and deduct a consumed usage from the total allowanced usage shared by multiple users;

the PCRF is configured to request the allowanced usage threshold from the SPR; make a usage monitoring policy according to the obtained allowanced usage threshold; and report the usage report to the SPR.

In the above solution, the system may further include:

a PCEF configured to perform a usage monitoring according to the usage monitoring policy distributed by the PCRF and report a usage to the PCRF;

the PCRF may be further configured to distribute the usage monitoring policy to the PCEF, allocate a usage threshold for each IP-CAN session or service data flow sharing the usage according to the allowanced usage threshold obtained from the SPR; and receive the usage reported by the PCEF.

In the above solution, after the PCEF reports the usage to the PCRF, the PCRF may be further configured to update the allowanced usage threshold with a value of a difference between the allowanced usage threshold and a consumed usage reported by the PCEF; and reallocate a new usage threshold that is smaller than or equal to the updated allowanced usage threshold when the PCRF decides to continue to perform the usage monitoring and the allowanced usage threshold at this moment is greater than 0, and distribute the reallocated new usage threshold to the PCEF;

the PCEF may be further configured to continue to perform the usage monitoring according to the received new usage threshold.

In the above solution, the PCRF may be configured to report a usage to the SPR when the updated allowanced usage threshold is equal to 0, when the IP-CAN session is terminated, or when the SPR requests the PCRF to make a report.

It can be seen from the technical solution provided above, a total allowanced usage is prestored in a SPR, the SPR sets an allowanced usage threshold according to a request from a PCRF and distributes the set allowanced usage threshold to the PCRF; the PCRF makes a usage monitoring policy according to the obtained allowanced usage threshold; the SPR deducts a consumed usage from the total allowanced usage shared by multiple users after receiving a usage report from the PCRF. In the method of the present disclosure, when multiple users share a total allowanced usage, PCRF simultaneously monitors the usage on the multiple users according to the total allowanced usage, thereby avoiding conflicts in policy and charging controls

### BRIEF DESCRIPTION OF THE DRAWINGS

FIG. 1 is a schematic diagram of the architecture of existing PCC;

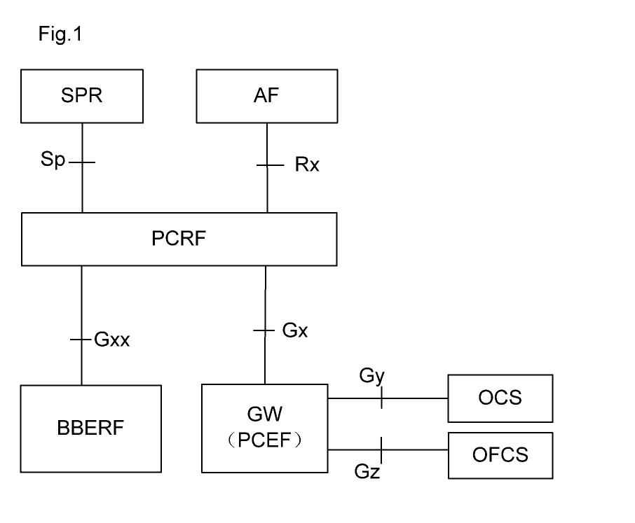

FIG. 2 is a flow chart of a method for implementing usage monitoring control according to the present disclosure;

FIG. 3 is a flow chart of an embodiment of the method for implementing usage monitoring control according to the present disclosure;

FIG. 4 is a flow chart of a first embodiment for implementing the usage report of FIG. 3;

FIG. 5 is a flow chart of a second embodiment for implementing the usage report of FIG. 3;

FIG. 6 is a flow chart of a third embodiment for implementing the usage report of FIG. 3.

### DETAILED DESCRIPTION

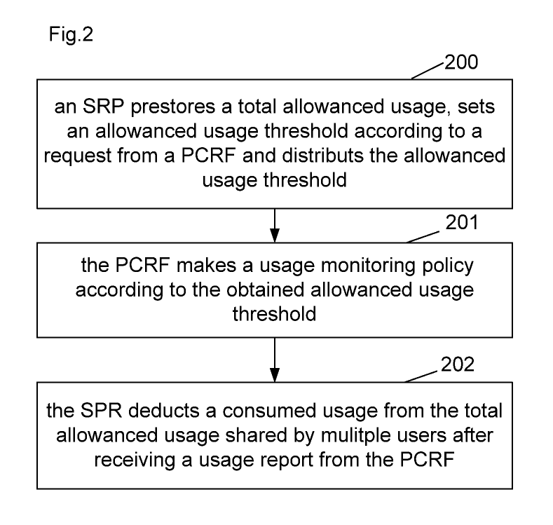

FIG. 2 is a flow chart of a method for implementing usage monitoring control according to the present disclosure. As shown in FIG. 2, the flow includes:

Step 200: an SRP prestores a total allowanced usage, sets an allowanced usage threshold according to a request from a PCRF and distributes the allowanced usage threshold;

In this step, assuming that the total allowanced usage of the IP-CAN session or service data flows shared by multiple users is TAU, then the SPR allocates an allowanced usage threshold AUTi for users who initiate the request and share the IP-CAN session or service data flows of the total allowanced usage, respectively, wherein AUTi is smaller than TAU, and i represents a different user.

Step 201: the PCRF makes a usage monitoring policy according to the obtained allowanced usage threshold;

here, the usage monitoring policy includes a usage threshold allocated by the PCRF for the users sharing the total allowanced usage of the IP-CAN session or service data flow;

In this step, the PCRF obtains the allowanced usage threshold for the users sharing the total allowanced usage, wherein the allowanced usage threshold is contained in the user subscription information returned by the SPR;

the PCRF makes a policy according to the returned subscription data, wherein the policy includes event triggers, such as a usage report event, a usage monitoring policy for a certain IP-CAN session or a certain specific service data flow and a Monitoring Key for a whole IP-CAN session or certain service data flows. The PCRF allocates a usage threshold UTi for the Monitoring Key, wherein UTi is smaller than or equal to AUTi.

Step 202: the SPR deducts a consumed usage from the total allowanced usage shared by multiple users after receiving a usage report from the PCRF,

In the step, when any one of or any combination of the following conditions are satisfied, the PCRF reports a usage to the SPR:

the updated allowanced usage threshold is 0; terminating the IP-CAN session; and the SPR requests the PCRF to make a report;

after the usage monitoring policy is made, and before the SPR receives a usage report from the PCRF, the method further includes: the PCRF distributes the usage monitoring policy to a PCEF, and the PCEF performs a usage monitoring according to the usage monitoring policy distributed by the PCRF and reports the usage to the PCRF. Here, the report of the usage by the PCEF may occur when an event requiring a usage report is triggered, for example, a usage monitored by a certain Monitoring Key (including IP-CAN session level and service data flow level) reaches a threshold, or the like; it also may be triggered by terminating the IP-CAN session; and it also may be triggered when the PCRF requests the PCEF to make a report, or the like.

After the PCEF reports a usage to the PCRF, the PCRF updates the allowanced usage threshold with a value of a difference between the allowanced usage threshold and the consumed usage reported by the PCEF, and when the PCRF decides to continue to perform a usage monitoring and the allowanced usage threshold at this moment is greater than 0, then the PCRF reallocates a new usage threshold that is smaller than or equal to the updated allowanced usage threshold; and the PCEF continues to perform a usage monitoring according to the received new usage threshold;

the deduction of the consumed usage from the total allowanced usage shared by the multiple users includes: if the usage report received by the SPR is an allowanced usage consumption value, then the total allowanced usage is updated with a value of a difference between the total allowanced usage and the received allowanced usage consumption value; and if the usage report received by the SPR is a remaining allowanced usage, then the total allowanced usage is updated with a value of a difference between the total allowanced usage and the allowanced usage threshold, plus the received remaining allowanced usage.

For the method of the present disclosure, a system for implementing usage monitoring control is also provided, which includes at least a PCRF and an SPR, wherein

the SPR is configured to store a total allowanced usage, set an allowanced usage threshold, and distribute the allowanced usage threshold according to a request from a PCRF; receive a usage report from the PCRF, and deduct the consumed usage from the total allowanced usage shared by multiple users;

the PCRF is configured to request the allowanced usage threshold from the SPR; make a usage monitoring policy according to the obtained allowanced usage threshold; and report a usage to the SPR.

The system further includes a PCEF, which is configured to perform a usage monitoring according to the usage monitoring policy distributed by the PCRF and report a usage to the PCRF;

correspondingly, the PCRF is further configured to distribute the usage monitoring policy to the PCEF, allocate a usage threshold for each IP-CAN session or service data flow sharing the usage according to the allowanced usage threshold obtained from the SPR; and receive the usage reported by the PCEF.

After the PCEF reports a usage to the PCRF, the PCRF is further configured to update the allowanced usage threshold with a value of a difference between the allowanced usage threshold and the usage consumption value reported by the PCEF; when the PCRF decides to continue to perform a usage monitoring and the allowanced usage threshold at this moment is greater than 0, then the PCRF reallocates a new usage threshold that is smaller than or equal to the updated allowanced usage threshold, and distributes the reallocated new usage threshold to the PCEF;

the PCEF is further configured to continue to perform a usage monitoring according to the received new usage threshold.

The method of the present disclosure will be described below in detail with reference to embodiments.

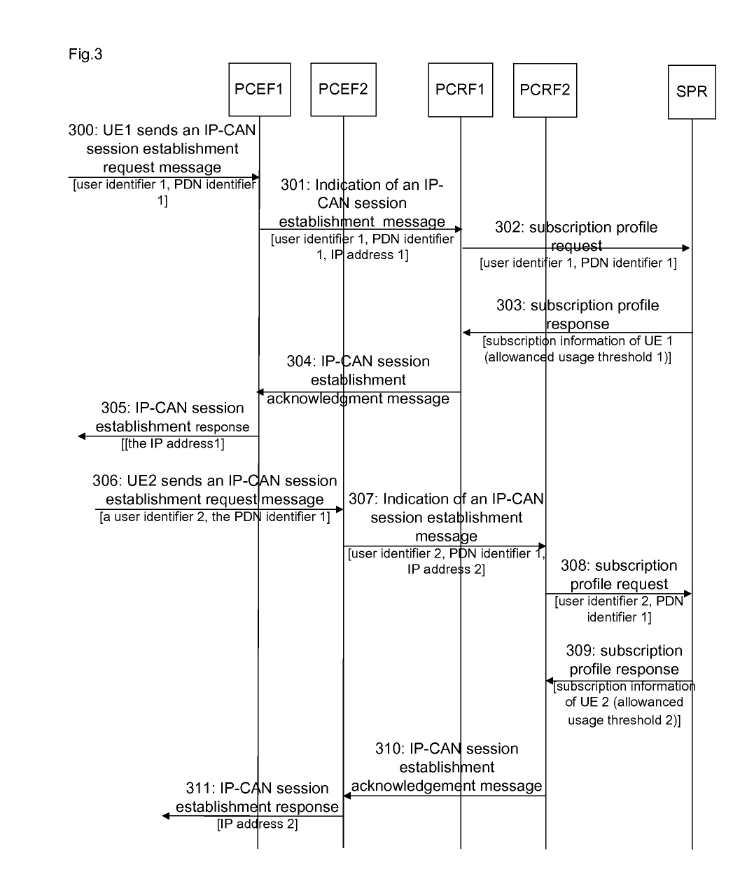

FIG. 3 is a flow chart of an embodiment of the method for implementing usage monitoring control according to the present disclosure, in this embodiment, there is described a case in which a UE1 and a UE2 share the TAU (Total Allowanced usage) of a PDN or the TAU of some specific data flows of a PDN; when UE1 and UE2 establish an IP-CAN session, respectively, an SPR distributes an AUT (allowanced usage threshold) to a PCRF, and the PCRF performs a usage monitoring control on the IP-CAN sessions established by UE1 and UE2 according to the AUT. As shown in FIG. 3, the method includes:

Step 300: UE1 sends an IP-CAN session establishment request message to a PCEF 1;

specifically, during the process of requesting the establishment of an IP-CAN session 1, UE1 sends an IP-CAN session establishment request message to the PCEF 1, in which the user identifier 1 of UE 1 and the PDN identifier 1 of the PDN network requested to be accessed are carried.

Step 301: the PCEF 1 sends an indication of IP-CAN session establishment message to a PCRF1, in which the user identifier 1, the PDN identifier 1 and an IP address 1 allocated to UE 1 are carried.

Step 302: the PCRF 1 sends a subscription profile request to an SPR, in which the user identifier 1 and the PDN identifier 1 are carried.

Step 303: the SPR returns a subscription profile response message according to the user identifier 1 and the PDN identifier 1, in which the subscription information of UE 1 is included;

in this step, since UE1 and UE2 share the total allowanced usage for the PDN identifier 1 or share the total allowanced usage of some specific service flows of the PDN identifier 1, the SPR allocates an allowanced usage threshold AUT 1 for the IP-CAN session 1 of the UE1, wherein AUT 1 is smaller than TAU. The SPR returns a subscription information including AUT1 to the PCRF 1.

Step 304: the PCRF 1 makes a usage monitoring policy according to the returned subscription information including AUT1, and sends an IP-CAN session establishment acknowledgement message to the PCEF1, in which the usage monitoring policy is carried;

specifically, the PCRF 1 makes a usage monitoring policy according to the returned subscription information including AUT1, wherein the usage monitoring policy includes an event trigger—Usage_Report, a usage monitoring policy for the IP-CAN session 1 or some specific data flows and a Monitoring Key for a whole IP-CAN session or some service data flows. The PCRF 1 allocates a usage threshold UT1 for a Monitoring Key and sends the UT 1 to the PCEF 1, wherein UT1 is smaller than or equal to AUT1.

Step 305: the PCEF 1 returns an IP-CAN session establishment response to UE1, in which the IP address 1 is carried.

After Steps 300-305, the PCEF 1 performs a usage monitoring on the IP-CAN session 1 established by UE1 according to the usage monitoring policy distributed by the PCRF 1.

Step 306: a UE2 sends an IP-CAN session establishment request message to a PCEF 2;

specifically, during the process of requesting the establishment of an IP-CAN session 2, UE2 sends an IP-CAN session establishment request message to the PCEF 2 to request the establishment of the IP-CAN session 2, wherein the user identifier 2 of UE 2 and the PDN identifier 1 of the PDN network requested to be accessed are carried in the IP-CAN session establishment request message.

Here, the PCEF 1 may be the same as the PCEF 2 or not, and it is assumed in this embodiment that the PCEF 1 is different from the PCEF 2.

Step 307: the PCEF 2 sends an indication of IP-CAN session establishment message to a PCRF2, in which the user identifier 2, the PDN identifier 1 and an IP address 2 allocated to the UE 2 are carried. Here, the PCRF 2 may be the same as the PCRF 1 or not, and it is assumed in this embodiment that the PCRF 1 is different from the PCRF 2.

Step 308: the PCRF 2 sends a subscription profile request to an SPR, in which the user identifier 2 and the PDN identifier 1 are carried.

Step 309: the SPR returns a subscription profile response message according to the user identifier 2 and the PDN identifier 1, wherein the subscription information of the UE 2 is included in the subscription profile response message;

in this step, since UE 1 and UE 2 share the PDN identifier 1 or share the total allowanced usage TAU of a certain service, the SPR allocates an allowance usage threshold AUT2 for the IP-CAN session 1 of UE 2 and returns AUT2 to the PCRF 2, wherein the sum of AUT 1 and AUT2 is smaller than or equal to TAU.

Step 310: the PCRF 2 makes a usage monitoring policy according to the returned subscription information including the allowance usage threshold AUT2, and sends an IP-CAN session establishment acknowledgement message to the PCEF 2, in which the usage monitoring policy is carried;

specifically, the PCRF 2 makes a usage monitoring policy according to the returned subscription information including the allowance usage threshold AUT2, wherein the usage monitoring policy includes an event trigger—Usage_Report, a usage monitoring policy for the IP-CAN session 2 or some specific data flows and a Monitoring Key for a whole IP-CAN session or some service data flows. The PCRF 2 allocates a usage threshold UT2 for a Monitoring Key and sends the UT 2 to the PCEF 2, wherein UT2 is smaller than or equal to AUT2.

Step 311: the PCEF 2 returns an IP-CAN session establishment response to UE2, in which the IP address 2 is carried.

Up till now, UE 2 establishes the IP-CAN session 2, The PCRF 1 and PCRF 2 obtain the allowanced usage threshold TAU1 and TAU2 from the SPR, respectively, and allocate the usage monitoring policy to the PCEF 1 and the PCEF 2, respectively, in which the usage threshold AU1 and AU2 are included. The PCEF 1 and the PCEF 2 perform a usage monitoring.

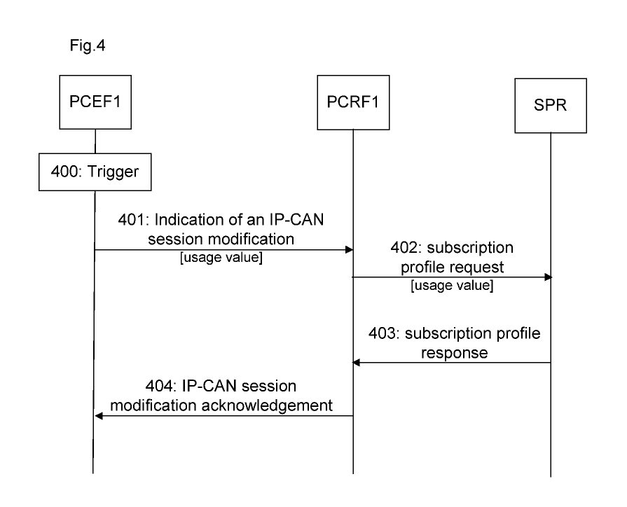

FIG. 4 is a flow chart of a first embodiment for implementing the usage report of FIG. 3, the first embodiment describes a flow for the PCEF 1 to implement a usage report after the establishment of a usage monitoring. As shown in FIG. 4, the flow includes:

Step 400: the PCEF 1 detects that an event requiring a usage report is triggered, wherein the triggering may be that a usage monitored by a certain Monitoring Key (including IP-CAN session level and service data flow level) reaches a threshold or all PCC rules corresponding to a certain Monitoring Key are deleted or deactivated.

Step 401: the PCEF 1 sends an indication of IP-CAN session modification message to the PCRF1, in which an event trigger value including Usage_Report and a Usage Report Value 1 (URV1) are included. If the triggering condition is that a usage monitored by a certain Monitoring Key reaches a threshold, then, URV 1 is equal to AUT 1; and if the triggering condition is that all the PCC rules corresponding to a certain Monitoring Key are deleted or deactivated, then URV1 is smaller than or equal to UT 1.

In this step, the PCRF 1 updates the allowanced usage threshold AUT1 with a value of (AUT1−URV1). When the PCRF 1 decides to continue to perform a usage monitoring and AUT1 is greater than 0 at this moment, then PCRF 1 will allocate a new usage threshold UT1′ which is smaller than or equal to AUT1, and then executes Step 404; When the PCRF 1 decides to continue to perform a usage monitoring and AUT1 is equal to 0 at this moment, then the PCRF 1 executes Step 402; and When decides not to perform a usage monitoring, then the PCRF 1 executes Step 404.

Step 402: the PCRF 1 sends the SPR a subscription profile request message carrying an indication of allowanced usage report and Allowanced Usage Report Value AURV1, and in this case, AURV1 is equal to AUT1.

Step 403: the SPR 1 updates the total allowanced usage TAU with be a value of (TAU−AUT1). Since the SPR has already allocated an AUT2 for UE2, if the updated (TAU−AUT2) is greater than 0, the SPR will allocate a new allowanced usage threshold AUT1′ for UE 1, wherein AUT1′ is smaller than or equal to (TAU−AUT2). The SPR returns a subscription profile response message to the PCRF 1, if the SPR allocates a new allowanced usage threshold, then the allowanced usage threshold AUT1′ is carried; otherwise, no allowanced usage threshold is carried.

Step 404: the PCRF 1 returns an IP-CAN session modification acknowledgement message to the PCEF 1.

If a new allowanced usage threshold AUT1′ is carried in the subscription profile response message, then the PCRF 1 allocates a new usage threshold UT1′ for UE 1 according to the AUT1′ returned by the SPR, wherein UT1′ is smaller than or equal to AUT1′, and the new usage threshold UT1′ is carried in the IP session modification acknowledgement message.

If the PCRF 1 distributes a new usage threshold UT1′, then the PCEF 1 continues to perform a usage monitoring; otherwise, the PCEF 1 does not perform a usage monitoring any longer.

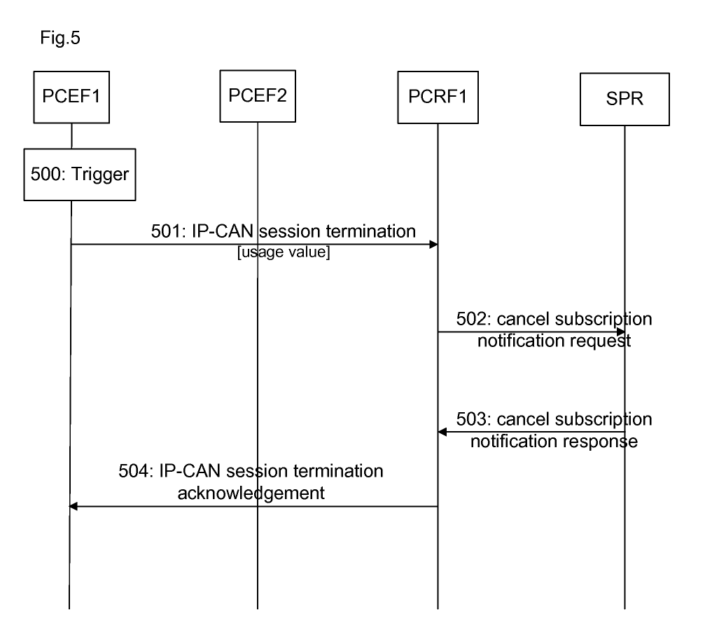

FIG. 5 is a flow chart of a second embodiment for implementing the usage report of FIG. 3, the second embodiment describes another flow for the PCEF 1 to implement a usage report after the establishment of a usage monitoring. As shown in FIG. 5, the flow includes:

Step 500: the PCEF 1 detects that the requirement of terminating the IP-CAN session1 is triggered, the triggering may be from other network elements, UE1 or PCEF1 itself.

Step 501: The PCEF1 sends an indication of IP-CAN session termination message, in which the usage consumption value of each Monitoring Key for performing usage monitoring is carried, to the PCRF 1, the usage consumption value is URV1 in the embodiment as shown in FIG. 3. Here, URV1 is smaller than or equal to UT1.

Step 502: the PCRF 1 updates the allowanced usage threshold AUT1 with a value of (AUT1−URV1). The PCRF 1 sends a cancel subscription notification request message to the SPR, in which an Allowanced Usage Report Value AURV1 of the Monitoring Key for performing a usage monitoring or a Remaining Allowanced Usage 1 RAU1 is carried, wherein AURV1 is equal to URV1 or the RAU1 is equal to AUT1.

Step 503: if the SPR receives the Allowanced Usage Report Value AURV1, then the SPR updates the total allowanced usage TAU with a value of (TAU−AURV1); if the SPR receives the Remaining Allowanced Usage RAU 1, the SPR updates the total allowanced usage TAU with a value of (TAU−AUT1+RAU 1), and returns a subscription cancel notification response to the PCRF 1.

Step 504: the PCRF 1 returns an IP-CAN session termination acknowledgement message to the PCEF 1.

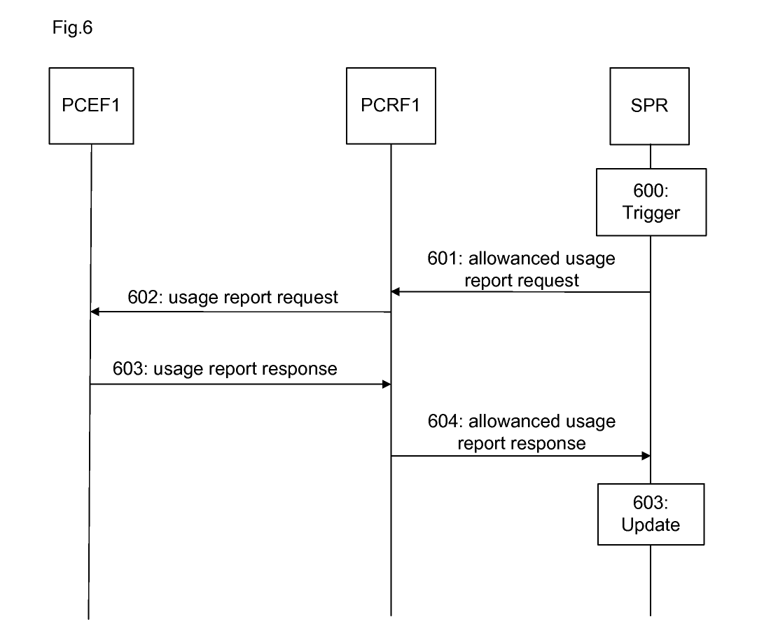

FIG. 6 is a flow chart of a third embodiment for implementing the usage report of FIG. 3, the third embodiment describes a flow for the SPR to request a usage report after the establishment of a usage monitoring. As shown in FIG. 6, the flow includes:

Step 600: the SPR detects that an event that requires the PCEF 1 to report the usage consumed is triggered.

Step 601: the SPR sends an allowanced usage report request message to the PCRF 1 to request the PCRF 1 to report an allowanced usage, wherein the Monitoring Key to be reported is carried in the allowanced usage report request message.

Step 602: the PCRF 1 sends a usage report request message to the PCEF 1 to request the PCEF 1 to report a usage consumed, wherein the Monitoring Key to be reported is carried in the usage report request message.

Step 603: the PCEF 1 sends a usage report response message to the PCRF 1, in which the Usage Report Value URV 1 of the Monitoring Key to be reported is carried. In this case, URV1 is smaller than or equal to UT1.

Step 604: the PCRF 1 updates the Allowanced Usage Threshold AUT1 of the Monitoring Key to be a value of (AUT1−URV1). The PCRF 1 sends the SPR an allowanced usage report response message carrying the Allowanced Usage Report Value AURV1 of the Monitoring Key to be reported or the Remaining Allowanced Usage RAU 1, wherein AURV1 is equal to the URV1 or the RAU1 is equal to AU1.

In this step, if the SPR receives the Allowanced Usage Report Value AURV1, then the Total Allowanced Usage TAU of the Monitoring Key is updated with value of (TAU−AURV1); or if the SPR receives the Remaining Allowanced Usage RAU 1, then the Total Allowanced Usage TAU of the Monitoring Key is updated with a value of (TAU−AUT1+RAU).

When the PCRF 1 does not receive an allowanced usage report request message send by the SPR, it may also send a usage report request message to the PCEF 1 in response to a triggering condition of the PCRF 1 itself, see Steps 602-603.

In the embodiments as described in FIG. 3-6, UE1 and UE2 share the total allowanced usage, and UE1 and UE2 only establish one IP-CAN session for one APN (i.e. PDN ID1), respectively. The method of the present disclosure is also applicable to the case in which UE1 and UE2 establish multiple IP-CAN sessions for one APN (i.e. PDN ID1), respectively, the specific implementations in accordance with the method of the present disclosure can be easily obtained by persons skilled in the art according to the foregoing embodiments and will not be described herein.

Although the above embodiments describe the implementation flows for usage monitoring control in the case where two users share a subscribed total allowanced usage, the flows for usage monitoring control in the case where more than two users share a subscribed total allowanced usage are similar.

The above embodiments are only preferred embodiments of the present disclosure, and not intend to limit the protection scope of the present disclosure, any modification, equivalent replacement and improvement within the principle of the present disclosure should be included in the protection scope of the present disclosure.

1. A method for implementing usage monitoring control, comprising:
prestoring a total allowanced usage in a Subscription Profile Repository (SPR);
setting, by the SPR, an allowanced usage threshold according to a request from a Policy and Charging Rules Function (PCRF) and distributing, by the SRP, the set allowanced usage threshold to the PCRF;
making, by the PCRF, a usage monitoring policy according to the obtained allowanced usage threshold;
deducting, by the SPR, a consumed usage from the total allowanced usage shared by multiple users after receiving a usage report from the PCRF.

2. The method according to claim 1, further comprising: distributing, by the PCRF, the usage monitoring policy to a Policy and Control Enforcement Function (PCEF) after the usage monitoring policy is made and before the SPR receives the usage report from the PCRF, and performing, by the PCEF, a usage monitoring according to the usage monitoring policy, and reporting, by the PCEF, a usage to the PCRF.

3. The method according to claim 2, wherein the usage monitoring policy comprises a usage threshold, which is smaller than or equal to the allowanced usage threshold.

4. The method according to claim 1, wherein when a first user in the multiple users requests to establish an IP-Connectivity Access Network (IP-CAN) session, the step of obtaining, by the PCRF, the allowanced usage threshold comprises:
including, by the SPR, the allowanced usage threshold in a subscription information of the users and returning the subscription information to the PCRF;
wherein the allowanced usage threshold is a first allowanced usage threshold.

5. The method according to claim 4, wherein the first allowanced usage threshold is smaller than or equal to the total allowanced usage,
the first allowanced usage threshold is for all service data flows of a certain IP-CAN session or for one or more service data flows in a certain IP-CAN session.

6. The method according to claim 5, wherein the usage monitoring policy comprises allocating, by the PCRF, a first usage threshold for a Monitoring Key, and the first usage threshold is smaller than or equal to the first allowanced usage threshold.

7. The method according to claim 5, wherein when a second user in addition to the first user in the multiple users requests to establish an IP-CAN session,
including, by the SPR, a second allowanced usage threshold in the subscription information of the users and returning the subscription information to the PCRF,
wherein a sum of the first allowanced usage threshold and the second allowanced usage threshold is smaller than or equal to the total allowanced usage.

8. The method according to claim 7, wherein the usage monitoring policy comprises allocating, by the PCRF, a second usage threshold for a Monitoring Key, wherein the second usage threshold is smaller than or equal to the second allowanced usage threshold.

9. The method according to claim 2, wherein a triggering condition for reporting the usage to the PCRF is: when an event requiring a usage report is triggered; and/or when the IP-CAN session is terminated; and/or the PCRF requests the PCEF to make a report.

10. The method according to claim 9, further comprising: updating, by the PCRF, the allowanced usage threshold with a value of a difference between the allowanced usage threshold and a consumed usage reported by the PCEF after the usage is reported to the PCRF,
reallocating, by the PCRF, a new usage threshold when the PCRF decides to continue to perform the usage monitoring and the allowanced usage threshold at this moment is greater than 0, wherein the new usage threshold is smaller than or equal to the updated allowanced usage threshold.
continuing, by the PCEF, the usage monitoring according to the received new usage threshold.

11. The method according to claim 10, wherein the PCRF reports the usage to the SPR when the PCRF satisfies one of or any combination of the following conditions:
the updated allowanced usage threshold is 0; when the IP-CAN session is terminated; and the SPR requests the PCRF to make a report.

12. The method according to claim 1, wherein the step of deducting, by the SPR, the consumed usage from the total allowanced usage shared by the multiple users comprises:
if the usage report received by the SPR is an allowanced usage consumption value, then the total allowanced usage is updated with a value of a difference between the total allowanced usage and the received allowanced usage consumption value; if the usage report received by the SPR is a remaining allowanced usage, then the total allowanced usage is updated with a value of a difference between the total allowanced usage and the allowanced usage threshold, plus the received remaining allowanced usage.

13. A system for implementing usage monitoring control, comprising at least a PCRF and an SPR, wherein
the SPR is configured to store a total allowanced usage, set an allowanced usage threshold, and distribute the allowanced usage threshold according to a request of the PCRF; receive a usage report from the PCRF, and deduct a consumed usage from the total allowanced usage shared by multiple users;
the PCRF is configured to request the allowanced usage threshold from the SPR; make a usage monitoring policy according to the obtained allowanced usage threshold; and report the usage report to the SPR.

14. The system according to claim 13, further comprising:
a PCEF configured to perform a usage monitoring according to the usage monitoring policy distributed by the PCRF and report a usage to the PCRF;
wherein the PCRF is correspondingly further configured to distribute the usage monitoring policy to the PCEF, allocate a usage threshold for each IP-CAN session or service data flow sharing the usage according to the allowanced usage threshold obtained from the SPR; and receive the usage reported by the PCEF.

15. The system according to claim 14, wherein the PCRF is further configured to update the allowanced usage threshold with a value of a difference between the allowanced usage threshold and a consumed usage reported by the PCEF after the PCEF reports the usage to the PCRF; and reallocate a new usage threshold that is smaller than or equal to the updated allowanced usage threshold when the PCRF decides to continue to perform the usage monitoring and the allowanced usage threshold at this moment is greater than 0, and distribute the reallocated new usage threshold to the PCEF;
the PCEF is further configured to continue to perform the usage monitoring according to the received new usage threshold.

16. The system according to claim 15, wherein the PCRF is configured to report a usage to the SPR when the updated allowanced usage threshold is equal to 0, when the IP-CAN session is terminated, or when the SPR requests the PCRF to make a report.

17. The method according to claim 2, wherein when a first user in the multiple users requests to establish an IP-Connectivity Access Network (IP-CAN) session, the step of obtaining, by the PCRF, the allowanced usage threshold comprises:
including, by the SPR, the allowanced usage threshold in a subscription information of the users and returning the subscription information to the PCRF;
wherein the allowanced usage threshold is a first allowanced usage threshold.

18. The method according to claim 17, wherein the first allowanced usage threshold is smaller than or equal to the total allowanced usage,
the first allowanced usage threshold is for all service data flows of a certain IP-CAN session or for one or more service data flows in a certain IP-CAN session.

19. The method according to claim 18, wherein the usage monitoring policy comprises allocating, by the PCRF, a first usage threshold for a Monitoring Key, and the first usage threshold is smaller than or equal to the first allowanced usage threshold.

20. The method according to claim 18, wherein when a second user in addition to the first user in the multiple users requests to establish an IP-CAN session,
including, by the SPR, a second allowanced usage threshold in the subscription information of the users and returning the subscription information to the PCRF,
wherein a sum of the first allowanced usage threshold and the second allowanced usage threshold is smaller than or equal to the total allowanced usage.

21. The method according to claim 20, wherein the usage monitoring policy comprises allocating, by the PCRF, a second usage threshold for a Monitoring Key, wherein the second usage threshold is smaller than or equal to the second allowanced usage threshold.

22. The method according to claim 2, wherein the step of deducting, by the SPR, the consumed usage from the total allowanced usage shared by the multiple users comprises:
if the usage report received by the SPR is an allowanced usage consumption value, then the total allowanced usage is updated with a value of a difference between the total allowanced usage and the received allowanced usage consumption value; if the usage report received by the SPR is a remaining allowanced usage, then the total allowanced usage is updated with a value of a difference between the total allowanced usage and the allowanced usage threshold, plus the received remaining allowanced usage.
